(19) United States
(12) Patent Application Publication
(10) Pub. No.: US 2013/0174061 A1
(43) Pub. Date: Jul. 4, 2013

(54) Facilitating Consumers to Connect with Suitable Providers on World Wide Web (WWW)

(71) Applicant: CHATVANA LLC, San Jose, CA (US)

(72) Inventors: Jaihari Vethachalam Loganathan, Bangalore (IN); Jeelani Mahaboob Syed, Bangalore (IN)

(73) Assignee: CHATVANA LLC, San Jose, CA (US)

(21) Appl. No.: 13/731,113

(22) Filed: Dec. 31, 2012

Related U.S. Application Data
(60) Provisional application No. 61/583,177, filed on Jan. 4, 2012.

(51) Int. Cl. H04L 12/58

(52) U.S. Cl. CPC H04L 51/04
USPC 715/758

(57) ABSTRACT

An aspect of the present invention provides a convenient mechanism for connecting consumers with providers. In an embodiment, a server system receives a search phrase from a consumer specifying a set of requirements, and identifies a suitable provider matching the requirements. The server system creates a chat room as a response to receiving the search query, and facilitates both of the provider and the consumer to participate in created chat room. As the chat room is created automatically without additional (i.e., other than receiving search phrase) interactions with the consumer, the provided interfaces are convenient.

### RELATED APPLICATIONS

The present application claims priority from co-pending U.S. provisional application entitled, “SEARCH INTERACTIVITY BROKER”, Application No. 61/583,177, filed on: 4 Jan. 2012, naming as Inventor: Jaihari Vethachalam Loganathan, and is incorporated in its entirety herewith.

### BACKGROUND

1. Technical Field

The present disclosure generally relates to World Wide Web (WWW) based technologies, and more specifically to facilitating consumers to connect with suitable providers of desired product and/or services.

2. Related Art

A provider refers to a person, business, etc., (hereafter ‘party’) who has a product, service, information, etc., (hereafter ‘offering’) to offer. On the other hand, a consumer refers to a party, who is in need of an offering and can use such offering.

World Wide Web (WWW) refers to a system of interlinked hypertext documents accessed via the Internet. Typically, using a web browser, one can view web pages that may contain text, images, videos, and other multimedia, and navigate between them via hyperlinks.

Consumers often attempt to connect with suitable providers on WWW. There are several websites, which attempt to connect consumers with providers of corresponding offerings. It is generally desirable that the interaction for such connection be convenient for consumers and/or providers.

### BRIEF DESCRIPTION OF THE DRAWINGS

Example embodiments of the present invention are described with reference to the accompanying drawings briefly described below.

FIG. 1 is a block diagram illustrating an example environment (computing system) in which several aspects of the present invention can be implemented.

FIG. 2 is a flow chart illustrating the manner in which consumers are facilitated to connect with providers.

FIG. 3A-3D together depicts a user interface provided to consumers and providers in an embodiment.

FIGS. 4A-4H together depict the XML stanzas transmitted in an embodiment.

FIG. 5 is a sequence diagram illustrating on a time scale the manner in which consumers to connect with suitable providers.

FIG. 6 is a block diagram illustrating the details of a messaging and presence server, in an embodiment.

FIG. 7 is a block diagram illustrating the details of a digital processing system in which several aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

An aspect of the present invention provides a convenient mechanism for connecting consumers with providers. In an embodiment, a server system receives a search phrase from a consumer specifying a set of requirements, and identifies a suitable provider matching the requirements. The server system creates a chat room as a response to receiving the search query, and facilitates both of the provider and the consumer to participate in created chat room.

As the chat room is created automatically without additional (i.e., other than receiving search phrase) interactions with the consumer, the provided interfaces are convenient.

In an embodiment, the identified provider is automatically joined. Alternatively, a list of suitable providers is sent to the consumer, and data representing selection of one or more providers of interest (from the list) are received from the consumer. Only the selected providers are added to the chat room.

Several aspects of the invention are described below with reference to examples for illustration. However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

### 2. Example Environment

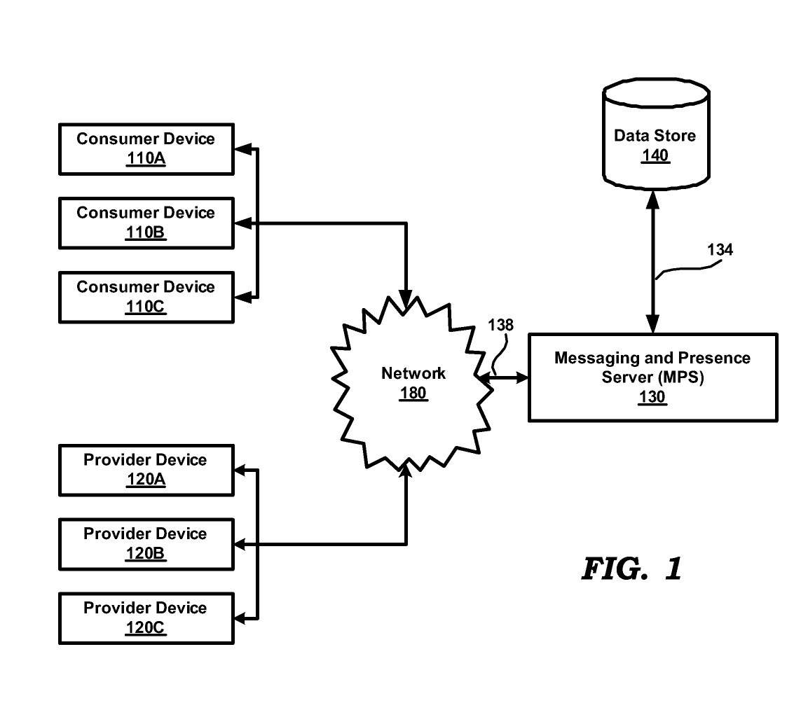

FIG. 1 is a block diagram illustrating an example environment (computing system) in which several aspects of the present invention can be implemented. The example environment is shown containing consumer devices 110A-110C, provider devices 120A-120C, messaging and presence server (MPS) 130, data store 140 and network 180.

Merely for illustration, only representative number/types of systems and locations are shown in the Figure. Many environments often contain many more systems, both in number and type, depending on the purpose for which the environment is designed. Each component/block of FIG. 1 is described below in further detail.

Network 180 provides connectivity between consumer devices 110A-110C, provider devices 120A-120C, and server 180. Network 180 may be implemented using protocols such as Internet Protocol (IP), well known in the relevant arts. In general, in TCP/IP environments, an IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by network 180.

Messaging and presence server (MPS) 130 provided according to an aspect of the present invention facilitates consumers to connect with providers. The ‘presence’ capability implies that MPS 130 tracks the (online) availability status of various users (either consumers or providers) and messaging capability implies the ability to exchange short messages (for interactive and real time communication, as opposed to asynchronous communications such as emails) with messaging clients. Messages may be exchanged using push approach (in which, the messages are sent/pushed by MPS 130 to the client, without waiting for a poll from the client).

In an embodiment, server 130 is implemented in accordance with Extensible Messaging and Presence Protocol (XMPP) described in further detail in Request for Comments (RFC): 6120 entitled, “Extensible Messaging and Presence Protocol (XMPP): Core” and RFC 3921 entitled, “Extensible Messaging and Presence Protocol (XMPP): Instant Messaging and Presence”. The description is accordingly continued assuming that the interactions are based on XMPP, even though alternative embodiments can be implemented using other protocols, without departing from the scope and spirit of several aspects of the present invention.

Data store 140 represents a non-volatile (persistent) storage, in which information related to various consumers, providers and communications facilitated by MPS 130 may be stored. For example, data store 140 may store information on the specific offerings (i.e., the topics) of each of the provider, presence status information of providers/consumers, any preferences of the consumers/providers, etc., which can be used as a basis for choosing the appropriate match of providers and consumers.

Data store 140 may also store authentication information for each of consumers and providers, such that each person may be authenticated for using the services provided by MPS 130. Data store 140 is assumed to be implemented as a corresponding database server using relational database technologies and accordingly providing storage and retrieval of data using structured queries such as SQL (Structured Query Language).

Each of consumer devices 110A-110C represents a system such as a personal computer, workstation, mobile devices (e.g., cell phone), tablets, etc., used by consumers to interact with various providers. Each consumer device 110A-110C first communicates with MPS 130 to identify suitable provider(s) to interact with, and thereafter interacts with the corresponding provider devices 120A-120C. Each consumer device is assumed to be implemented to operate as a XMPP client.

Each provider device 120A-120C can be a system similar to consumer device, but is used by a corresponding provider to interact with MPS 130 and desired consumers at the respective consumer devices. Each provider at a corresponding provider device is assumed to have an offering in specific specializations or topics.

The description is continued with respect to the manner in which MPS 130 may facilitate consumers to connect with providers according to features of the present invention.

### 3. Connecting Consumers and Providers

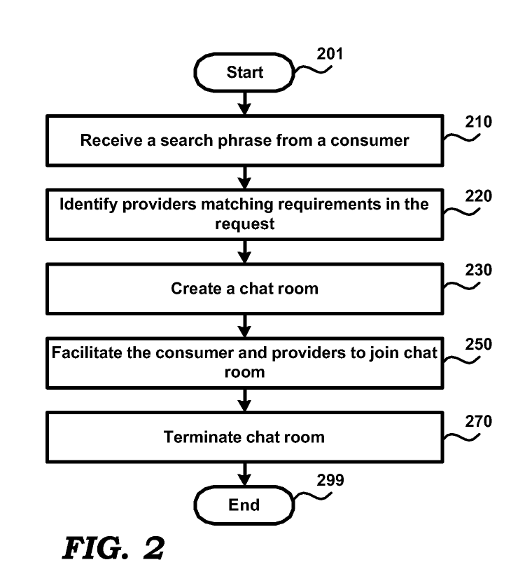

FIG. 2 is a flowchart illustrating the manner in which consumers are facilitated to connect with providers according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, in which control immediately passes to step 210.

In step 210, MPS 130 receives a search phrase from consumer device 110A. The search phrase can be in any format, but generally indicates the attributes specifying the requirements of the consumer. In an embodiment described below, the search phrase contains various terms in the form of corresponding text, that indicate the offering of interest, even though more complex structures can be used to specify the requirements, as will be apparent to a skilled practitioner based on the disclosure herein.

In step 220, MPS 130 identifies providers matching requirements specified in the search phrase. In an embodiment, MPS 130 selects only those providers that are ‘online’ (i.e., logged into MPS 130) and ‘available’ (where there status information can be interpreted to mean availability of the provider). Thus, expressed status such as ‘available’, ‘ready to talk’, etc. (which may be specified by the provider) may qualify a corresponding provider as being available.

In step 230, MPS 130 creates a (electronic) chat room as a response to the search phrase. In other words, without requiring further inputs from the consumer, a chat room is automatically created by MPS 130 as a part of processing the search phrase. Creation of a chat room implies providing the necessary state (e.g., creation of data structures, table entries, etc.) within MPS 130 such that the messages entered by one participant are automatically delivered in (near) real-time to the other participants. In an embodiment, the requesting consumer is automatically made a participant of the created chat room.

In step 250, MPS 130 facilitates the consumer and one or more of the providers to join the created chat room. Joining a chat room implies that the messages sent by one participant can be seen by other participants of the chat. In an embodiment, at least one provider (identified in step 220) is also made an automatic participant such that the messages by the consumer are transmitted to the provider and vice versa. Alternatively, MPS 130 automatically invites all the best matching providers into a chat room without any further input from user.

In another embodiment, the consumer is sent a list of suitable providers, and the consumer may select specific providers of further interest. Only the selected providers are thereafter joined in the chat room. In a scenario where more than one provider has (been selected and) joined the created chat room, the consumers may send/receive private messages (that are visible only to one intended participant and not to others) to/from each provider.

In step 260, MPS 130 terminates the chat session, for example, upon request of the consumer after necessary messages are exchanged. The flow chart ends in step 299.

The ease with which a consumer can connect with suitable providers is enhanced in view of the automatic provision of the chat room, as noted above. The description is continued with respect to an example user interface using which the features noted above can be provided.

### 4. Example User Interface

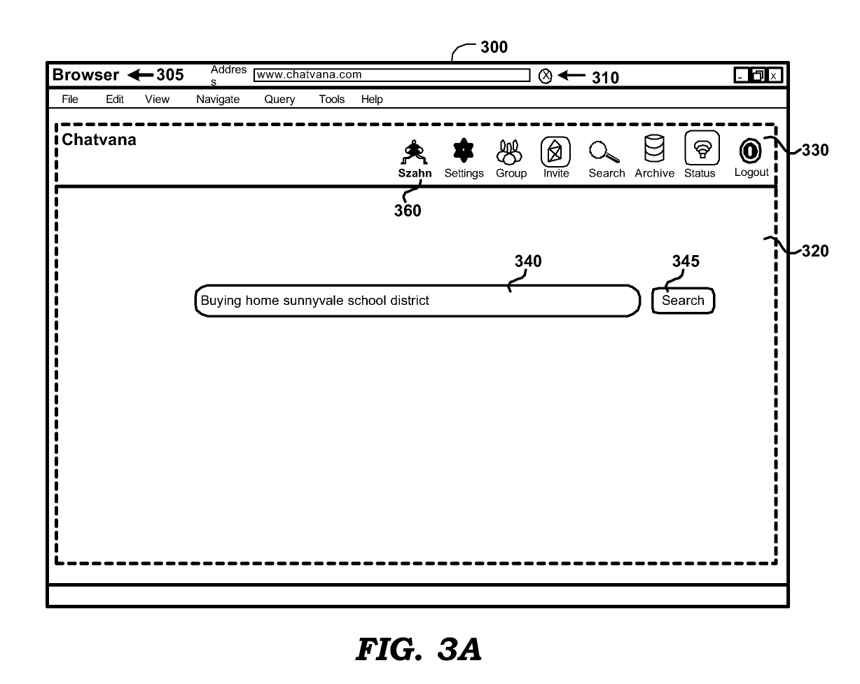

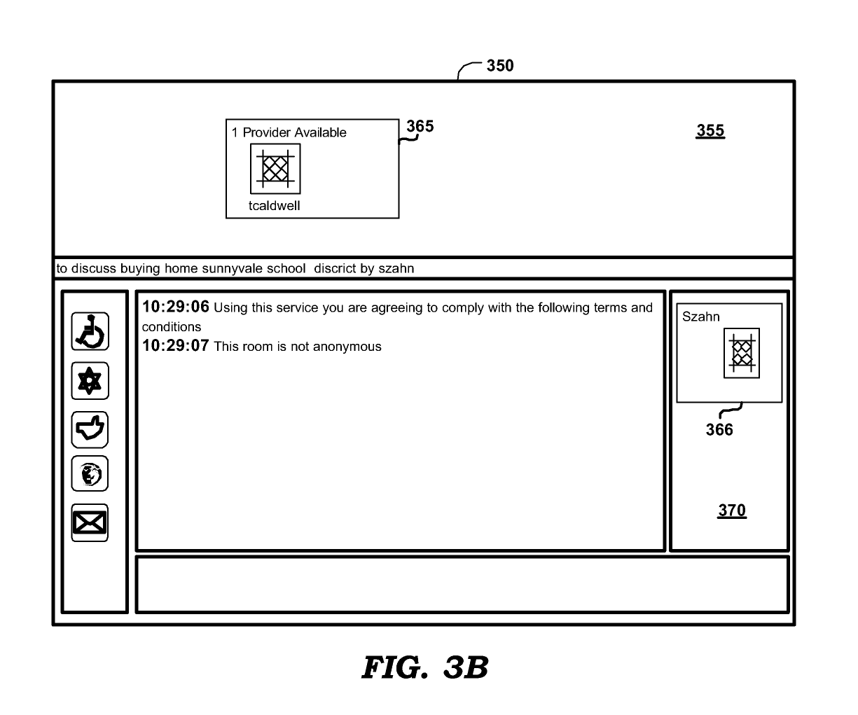

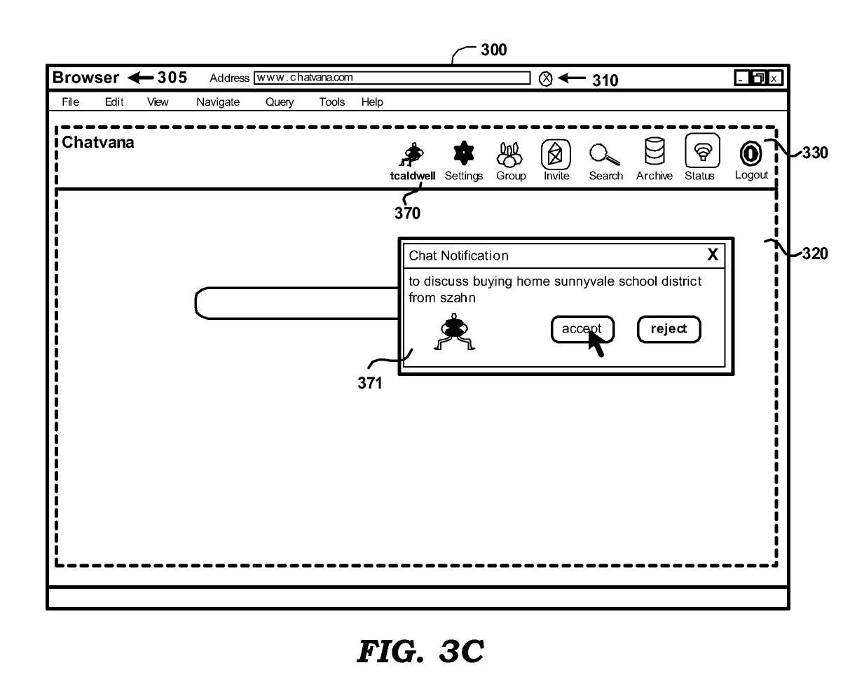

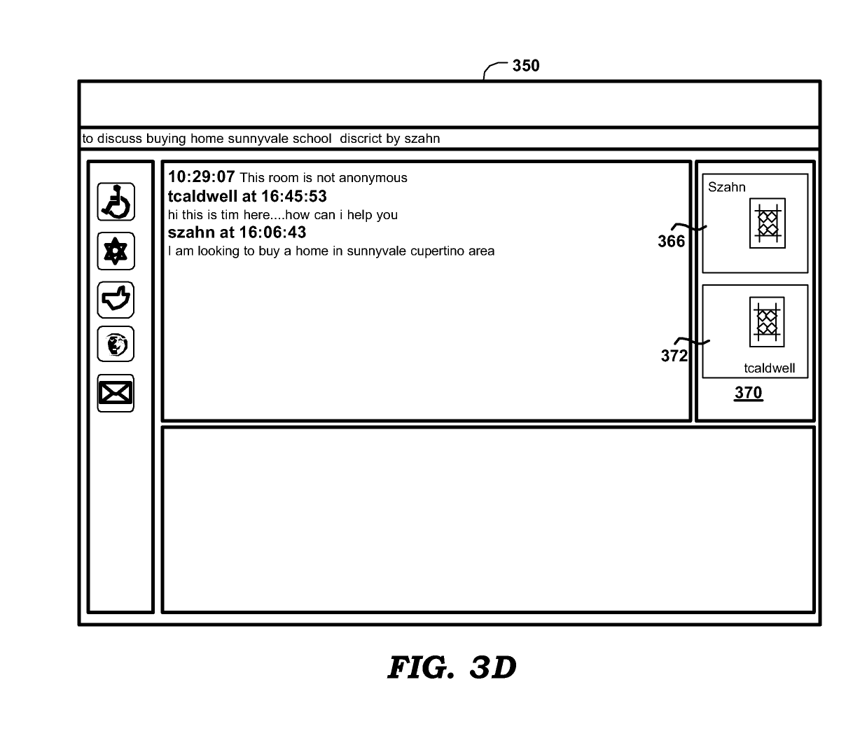

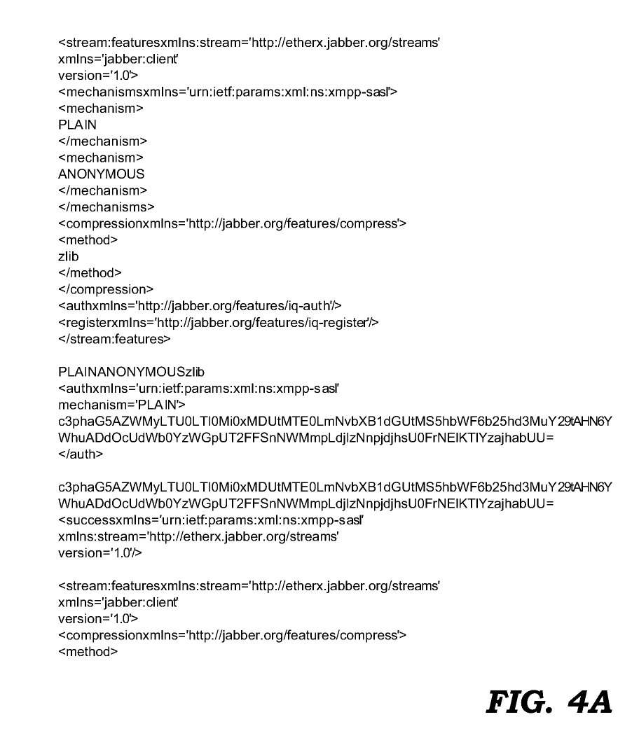

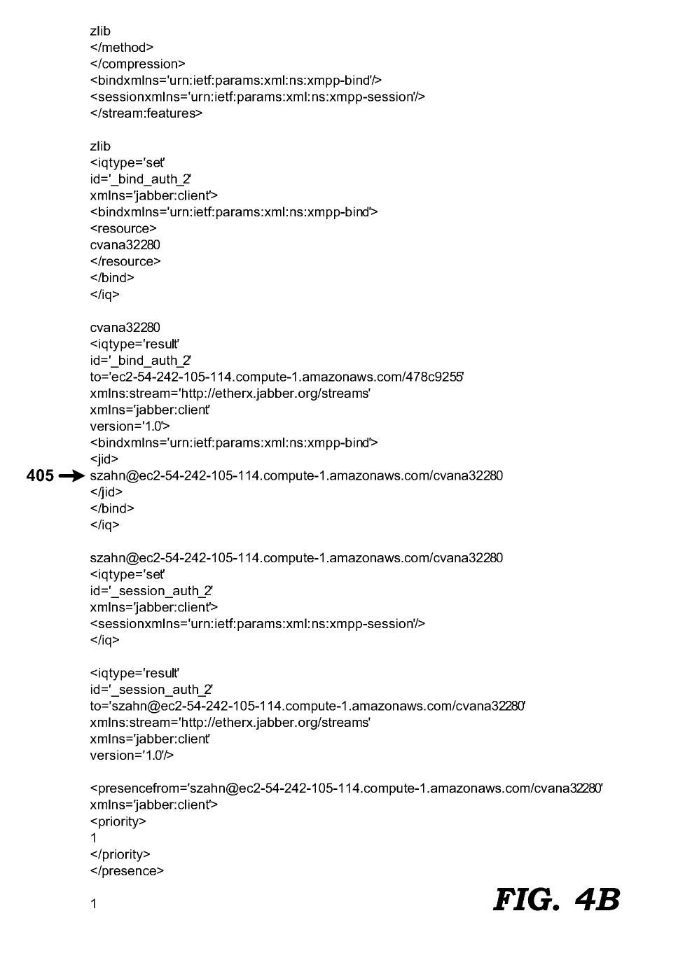

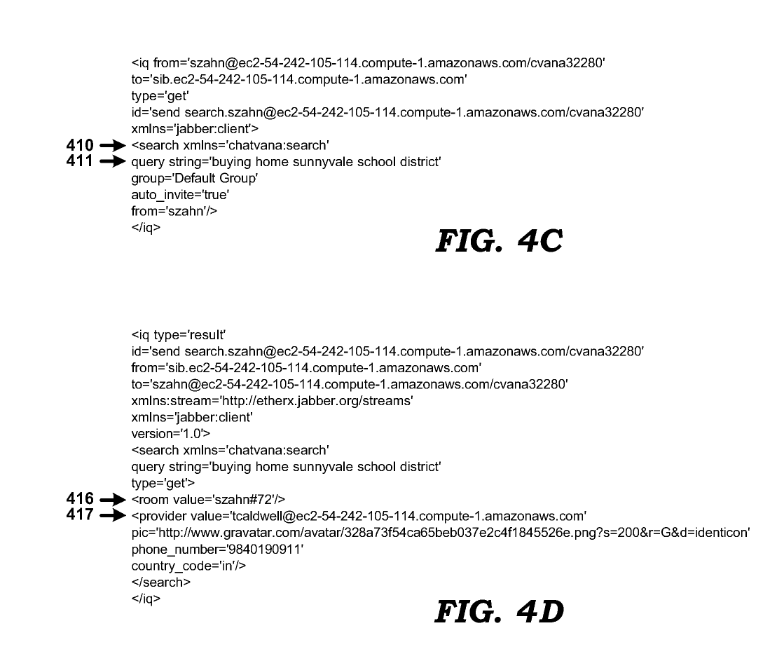

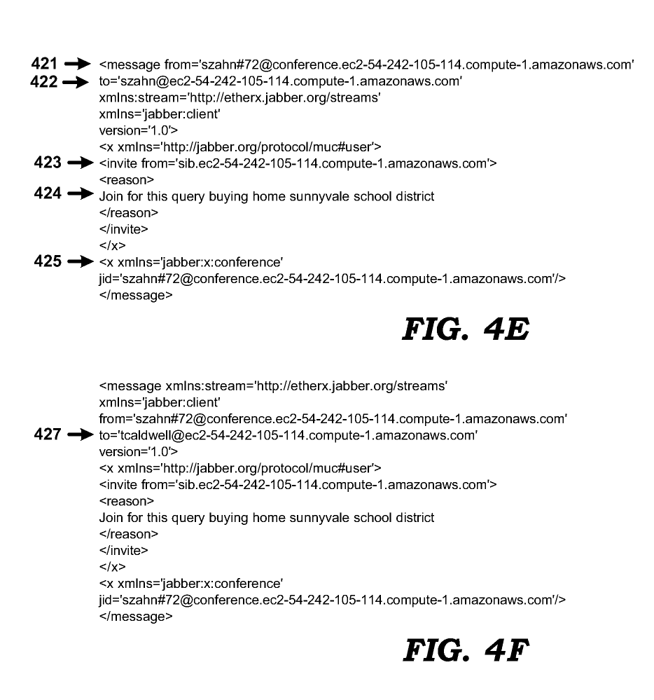

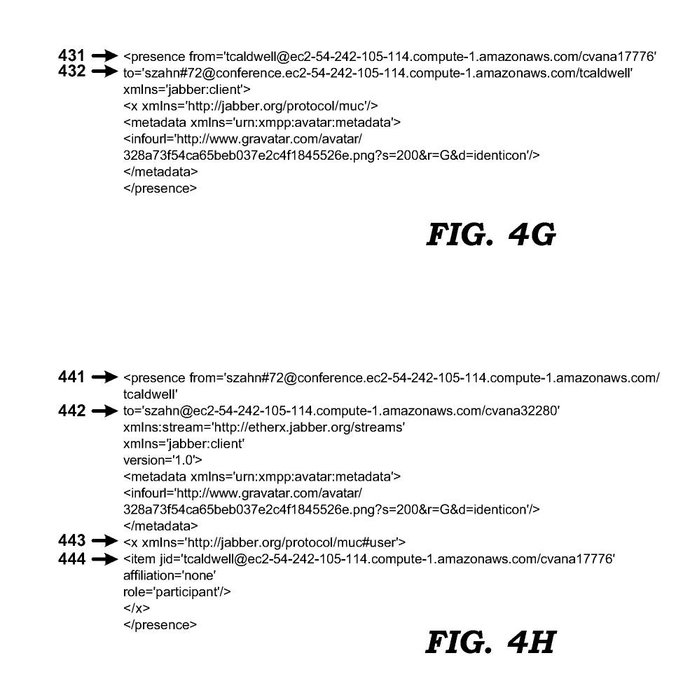

FIGS. 3A-3D together depicts a user interface provided by MPS 130 as a consumer connects with a suitable provider in one embodiment. FIGS. 4A-4H together depict the XML stanzas (XML stanzas defined in RFCs 6120 and 3921 referred to above) exchanged by consumer/provider devices with MPS 130 in such a transaction.

Referring to FIG. 3A, display area 300 depicts a portion of a user interface displayed on a display unit (not shown) of consumer device 110A after a consumer has logged on and presents a search phrase. Display area 300 corresponds to the display provided by a browser (as indicated by the text 305) when a consumer “Szahn” has accessed the web page at “http://www.chatvana.com” (as indicated by text 310). Thus, the user Szahn is shown as being logged in to the MPS server, as indicated by icon 360. However, in alternative embodiments, a consumer may connect with providers as an “anonymous login/guest login”, as will be apparent to one skilled in the relevant arts.

XML stanza in FIGS. 4A and 4B depict the XMPP handshake that takes place when Szahn, with jid (jabber id—the unique identification for every XMPP user) “szahn@ec2-54-242-105-114.compute-1.amazonaws.com/cvana32280” logs in to MPS 130. MPS 130 may thereafter consider the user to be ‘online’/present, until the user logs out of MPS 130.

Display area 320 represents a user interface provided by MPS 130 in the context of the browser. Each of the visual elements such as buttons, icons, radio buttons, etc. and layout elements such as horizontal/vertical lines used to mark the display areas, menu items (in display area 330), etc., may be viewed as a component of the user interface. Only a few components of interest are described below for conciseness.

Display area 340 represents a search box where a search phrase “Buying home Sunnyvale school district” has been entered by consumer Szahn. The search phrase contains text representing the requirements (here information on that topic) of user.

FIG. 4C depicts the XML stanza, representing the search phrase as a XMPP query, sent by consumer device 110A to MPS 130, on Szahn clicking the “search” button 345. Line 411 depicts the query string “buying home sunnyvale school district” entered by Szahn.

On receiving the query from Szahn, MPS 130 identifies providers matching the requirements specified in the query (search phrase), creates a chat room, and provides the corresponding information to the requesting consumer device.

FIG. 4D depicts the XML stanza sent by MPS 130 to consumer device 110A as a response to the search phrase. Line 416 depicts a chat room with room value “szahn#72” being created. Line 417 depicts the jids (Jabber Identifiers) of the matching providers—only one, tcaldwell@ec2-54-242-105-114.compute-1.amazonaws.com in this case.

FIG. 4E depicts the XML stanza sent by MPS 130 inviting szahn at consumer device 110A to join chat room szahn#72. Line 423 depicts SIB660 (with jid of sib.ec2-54-242-105-114.compute-1.amazonaws.com), a part of MPS 130 and described in below sections, inviting szahn (line 422) to chat room szahn#72 (line 421). It may be noted that consumer Szahn, who initiated the search query, is invited and automatically joined to the chat room szahn#72 created in response to the search query without any action on the part of consumer Szahn.

FIG. 3B depicts the chat room interface (display area 350) displayed to consumer Szahn on a display unit associated with consumer device 110A after receipt of the stanza of FIG. 4E. Icon 365 in display area 355 shows one provider, tcaldwel is available. If there are more providers than the number of providers whose icons can be accommodated in display area 355, the consumer may be provided with a facility to view the icons of providers which are not being displayed, for example by scrolling, etc. Icon 366, by its location in area 370, shows Szahn as a participant the chat room. While the display of FIG. 3B is rendered at consumer device 110A, in an embodiment, the service provider identified to be suitable may be invited to join as described below.

FIG. 4F depicts an XML stanza sent from MPS 130 to provider system 120A upon identification of tcaldwell at that system (line 427), as a suitable service provider. It is assumed that the provider is already logged in (similar to that described for the consumer at consumer device 110A above) and available to serve.

The stanza of FIG. 4F is sent automatically, assuming that consumer Szahn had preferred to automatically invite the best matched provider(s) to the chat room. In an alternative embodiment, consumers may be provided with the facility to invite one or more of the best matched providers to join the chat room, and only those providers who have been invited thus may be permitted to join the chat room.

In yet another alternative embodiment, if a matching provider is presently unavailable, a notification to that effect is sent to both the provider and the consumer. The service provider is automatically added to the chat room, once s/he becomes available.

FIG. 3C depicts the interface (similar to display area 300 of FIG. 3A) provided at provider system 120A while provider tcadwel is provided an option to accept the invitation. It is assumed that the provider accepts the invitation.

FIG. 4G depicts the XML stanza transmitted from provider system 120A to MPS 130 after the provider has accepted the invitation from MPS 130. Accordingly, MPS 130 may join provider system 120A to the chat room. Any necessary actions such as updating internal tables, data structures, etc., may be performed within MPS 130 to effect such a joining.

FIG. 4H depicts the XML stanza transmitted from MPS 130 to provider system 120A notifying that tcaldwel has joined chat room szahn#72. The display in area 370 is shown accordingly updated. Thereafter, the consumer (Szahn) and the provider (tcaldwel) may interact with each other in the chat room, as depicted in FIG. 3D (similar to display area 350 of FIG. 3B).

The description is continued with an example transaction sequence between the server and the consumers/providers.

### 5. Example Transaction Sequence

FIG. 5 is a sequence diagram (as a function of time) illustrating the manner in which MPS 130 facilitates consumers to connect with suitable providers on WWW. Broadly, events 510 through 525 illustrate the manner in which providers are enabled to register keywords representing their respective offerings with MPS 130 and events 530 through 555 illustrate the manner in which a consumer is enabled to find and communicate with providers of offerings of interest to the consumer in an embodiment.

In event 510, a provider (real estate agent), using a browser (assumed to be executing in provider device 120C) is shown sending to MPS 130, a set of key words characterizing his/her offerings. In event 515, MPS 130 is shown responding with an XMPP response, acknowledging that the key words have been accepted and stored in data store 140. Similarly, event 520 shows another provider (health care provider using provider device 120B) sending a set of key words characterizing his/her offerings and receiving an XMPP response (event 525), acknowledging that the key words have been accepted and stored in data store 140.

In event 530, a consumer is shown inputting the search phrase depicted in FIG. 3A, which is communicated to MPS 130 as an XML stanza, as described above. It is assumed that the consumer is inputting the search phrase from a browser client executing in consumer device 110A. However, in an alternative embodiment, the events of FIG. 5 may be associated with a mobile client executing in another consumer device (such as 110B).

In event 535, MPS 130 finds the best matched providers for the search query (comparing the words in the search phrase with the key words registered by the providers and stored in the data store), creates a chat room and make available the chat room as described above with respect to FIGS. 3A-3B and 4C-4D. In event 540, MPS 130 invites the consumer to the chat room (FIG. 4E), and in event 545, consumer device 110A joins the chat room, as explained above.

In event 550, MPS 130 invites a best matched provider to the chat room (FIG. 4F) created in event 535 above. In event 555, the providers who accept the invitation join the chat room. It may be appreciated that in alternate embodiments, MPS 130 may first send a list of matching service providers, enable the consumer to select a desire one(s) of the providers, and then invite only the selected provider(s) to the chat room, as described above.

Messaging and Presence Server (MPS) 130 thus facilitates consumers to connect with suitable providers on WWW, as described above. The details of MPS, in an embodiment, are described below.

### 6. Messaging and Presence Server (MPS)

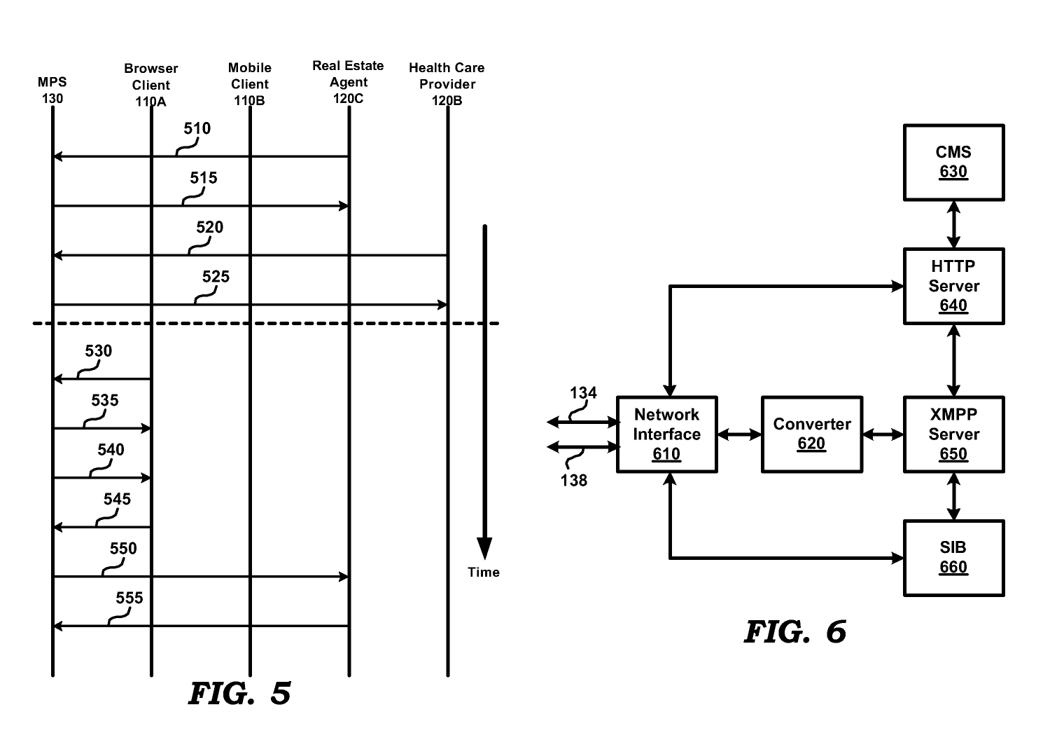

FIG. 6 is a block diagram illustrating the details of MPS 130 in an embodiment. MPS 130 is shown containing network interface 610, converter 620, content management system (CMS) 630, HTTP server 640, XMPP server 650, and search interactive broker (SIB) 660. It should be appreciated that MPS 130 may contain other blocks, but only the blocks as relevant to an understanding of the features of the present invention are shown for conciseness. Each of the blocks is described below in further detail.

Network interface 610 provides connectivity to network 180 (e.g., using Internet Protocol), and may be used to communicate with other connected systems (such as consumer/provider devices on path 138, and data store 140 on path 134, etc.).

HTTP server 640 serves the web pages that provide the basis for various interactions. For example, the web pages may be designed to seek authentication information from the consumers/providers (forming the basis for logging in) and provide respective user interfaces as described above with respect to FIGS. 3A-3D. In an embodiment, the web pages are encoded with appropriate JavaScript™ code to provide such interactions, and can be implemented in a known way by reading the disclosure provided herein.

CMS 630 provides content to be served by HTTP server 640. Among other information, CMS 630 provides a XMPP-domain for the consumer devices to connect to, a respective JID for each of the consumer devices, other consumer device configuration information (e.g., auto-invite option), etc.

Converter 620 implements Bidirectional-streams Over Synchronous HTTP (BOSH), which is a transport protocol that emulates a bidirectional stream between XMPP server 650 and the consumer/provider systems. As is well known, BOSH uses multiple synchronous HTTP request/response pairs without requiring the use of polling or asynchronous chunking, thereby enabling browsers (operating based on HTTP) to access XMPP server 650 (based on XMPP). BOSH allows clients to access the XMPP service through firewalls/NAT (Network Address Translation) which may not allow long lived TCP connections. The converter may also implement Websocket or similar protocols. In an embodiment, consumer devices may connect to the XMPP server directly (without using converter 620), for example, using XMPP over TCP.

XMPP server 620 implements XMPP stack. FIGS. 4A and 4B illustrate the XMPP initial handshake that authenticates the user (consumer or provider) and notes the user's presence/availability on the network.

SIB 660 processes the search phrase and creates chat rooms. SIB 660 requests XMPP server 620 to create and configure the chat room, invite the consumer to the chat room and invite the best matched providers to the chat room (if the consumer has chosen to automatically invite the best matched providers to the chat room).

Similarly, SIB 660 stores in a suitable memory (e.g., RAM) data indicating any suitable providers, who are then unavailable (when determined to be suitable), such that the provider can be added to the chat room upon becoming available.

SIB 660 may also support participation of only those service providers that are selected by a consumer. Specifically, the consumer may be sent a list of matching service providers (along with notification of creation of chat room), and SIB 660 thereafter receives the specific service providers selected by the consumer. Only such selected service providers are added as participants of the chat room. The consumer is a participant of the chat room when the list of matching service providers is sent.

It may be appreciated that each component in FIG. 6 can contain multiple instances by industry recognized scale out principles. Furthermore, the XMPP server may embody many JID sub-domains to which a set of users connect to enhance scalability. Each such sub-XMPP instance will talk to each other using Server to Server XMPP specification, as is well known in the arts. It should be noted that the database used for storing the Provider profile and Client information may be implemented by a no-SQL database as well to enhance scalability.

It may be further appreciated that MPS 130 may be implemented to provide additional features such as those described below with examples.

### 7. Additional Features

In an embodiment, if a provider who is identified as one of the best matched providers in response to a query from a consumer, is off line to take part in the chat, MPS 130 may store the details such as the search phrase, the matching provider who is not online, whether the consumer invited (automatically or by selection) the provider, etc. At a later time, when both the provider who was off line and the consumer comes online, MPS 130 may use the stored details to intimate the consumer that the provider is now online, and facilitate the consumer (such as creating the chat room, sending invitations to join the chat room, etc.) to connect to the provider.

Further, if the consumer was off line when the provider came online at the later time, MPS 130 may use the stored details to re-issue the search query to SIB 660 whenever the consumer comes online again.

According to another embodiment, MPS 130 stores the last time that a provider was included in the best matching providers list. This information is used to choose another provider for the best matched providers list for a similar query next time, thus giving all the providers a fair chance. Further, MOS 130 may implement various business logic such as including a provider more often in the best matched providers list if the provider pays more, changing the position of a provider in the best matched providers list to reflect positive or negative feed back from the consumers (a positive feed back improving the position in the list and vice versa), etc.

In one more embodiment of the invention, the providers (possibly, the best matched providers) can be invited to a private chat room by the consumer.

In yet another embodiment of the invention, consumers who are looking for the same information/product/service can be aggregated into a group. They can interact in a group and set a possible price for the item associated with the query (say a product or service). In such a scenario, a set of users can create a group and collaborate answering queries within the group. The scope of interaction may be limited to the members of group.

One embodiment of the invention runs the consumers queries against providers who are not registered yet. The information about the providers may be obtained in a known way, for example, based on web crawling. This allows statistics to be collected that can illustrate to the prospective providers the promise of the service.

It may be appreciated that by associating queries to chat conversations, MPS 130 enables building of a unique database that can be analyzed by businesses for trend analysis, demand forecasting, consumer sentiment analysis, market research etc. Such association may also form the basis for providing targeted advertisements (in a chat room) associated with what user is looking for.

It should be further appreciated that the features described above can be implemented in various embodiments as a desired combination of one or more of hardware, executable modules, and firmware. The description is continued with respect to an embodiment in which various features are operative when corresponding executable modules are executed.

### 8. Digital Processing System

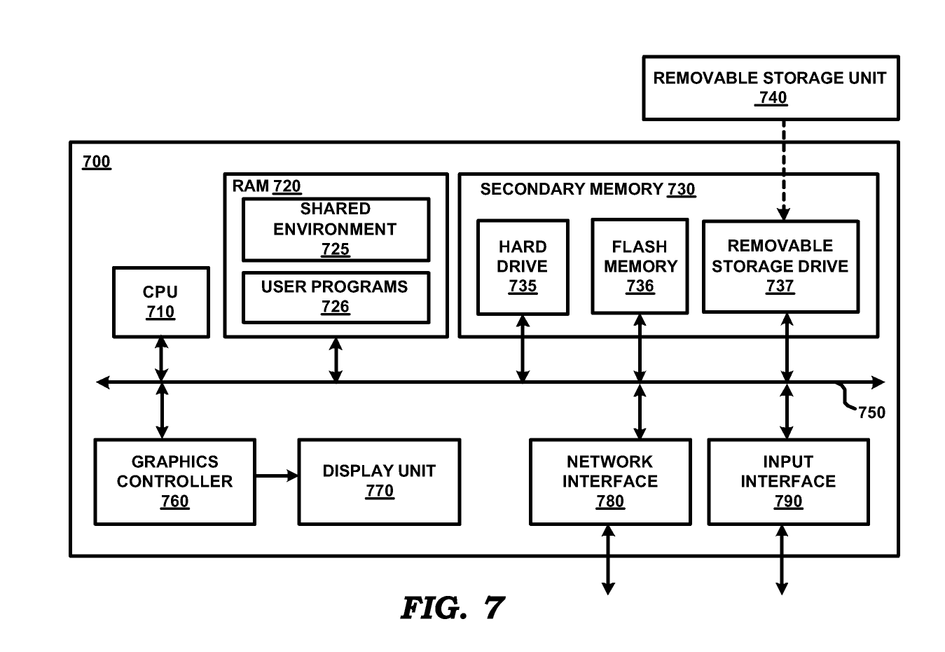

FIG. 7 is a block diagram illustrating the details of digital processing system 700 in which several aspects of the present invention are operative by execution of appropriate executable modules. Digital processing system 700 may correspond to any system (such as MPS 130) or any one of consumer devices 110A-110C or provider devices 120A-120C.

Digital processing system 700 may contain one or more processors (such as a central processing unit (CPU) 710), random access memory (RAM) 720, secondary memory 730, graphics controller 760, display unit 770, network interface 780, and input/output interface 790. All the components except display unit 770 may communicate with each other over communication path 750, which may contain several buses as is well known in the relevant arts.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit. RAM 720 may receive instructions from secondary memory 730 using communication path 750. RAM 720 is shown currently containing software instructions constituting shared environment 725 and/or user programs 726. Shared environment 725 contains utilities shared by user programs, and such shared utilities include operating systems, virtual machines, etc., which provide a (common) run-time environment for execution of user programs 726 (such as browsers, email client software).

Graphics controller 760 generates display signals (e.g., in RGB format) to display unit 770 based on data/instructions received from CPU 710. Display unit 770 contains a display screen to display the images defined by the display signals (for example, portions of the user interface shown in FIGS. 3A-3D). Input/output interface 790 includes input as well as output devices to enable a user to interact with system 700 (for example, to interact with the user interface of FIGS. 3A-3D such as entering a search phrase, connecting with providers on chat, etc.). Network interface 780 provides the physical, electrical and protocol implementations that enable system 700 to communicate with other systems of FIG. 1 using protocols such as TCP/IP.

Secondary memory 730 (representing a non-transitory storage/medium) may contain hard drive 735, flash memory 736, and removable storage drive 737. Secondary memory 730 may store data (for example, portions of the consumer provided inputs) and software instructions (for example, for performing the steps of FIG. 2), which enable digital processing system 700 to provide several features in accordance with the present invention, as described above.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. However, the computer (or machine, in general) readable storage medium can be in other forms (e.g., non-removable, random access, etc.).

In this document, the term “computer program product” is used to generally refer to secondary memory 730. These computer program products are means for providing software to digital processing system 700. CPU 710 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of example embodiments of the invention.

What is claimed is:

1. A method of connecting consumers with providers, said method being implemented in a server system, said method comprising:
maintaining presence information indicating that a plurality of consumers and a plurality of providers are presently logged in to said server system;
receiving a search phrase from a first consumer of said plurality of consumers, specifying a set of requirements;
identifying a first provider of said plurality of providers matching said set of requirements;
creating a chat room for said search query, as a response to receiving said search query; and
facilitating both of said first provider and said first consumer to participate in said chat room.

2. The method of claim 1, further comprising:
inviting said first provider to said chat room,
wherein said first provider becomes a participant of said chat room by accepting the invitation sent by said inviting,
wherein said first provider and said first consumer interact in said chat room upon joining said chat room.

3. The method of claim 2, wherein said first provider is unavailable when said invitation is sent, said method further comprising:
notifying said first consumer of the unavailability of said first provider; and
upon said first provider becoming available, facilitating said first provider to join said chat room.

4. The method of claim 1, wherein said first provider and said first consumer are invited to join said chat room as a response to said search query.

5. The method of claim 4, further comprising automatically joining said first provider and said first consumer to said chat room.

6. The method of claim 1, wherein said identifying identifies a set of providers matching said set of requirements, said response to said search query containing identifiers of said set of providers, said method further comprising:
receiving selection data representing said first provider, as having been selected by said first consumer; and
adding only said first provider, but not others of said plurality of providers, to said chat room.

7. A non-transitory machine readable medium storing one or more sequences of instructions for causing a server system to connect consumers with providers, wherein execution of said one or more sequences of instructions by one or more processors contained in said server system causes said server system to perform the actions of:
maintaining presence information indicating that a plurality of consumers and a plurality of providers are presently logged in to said server system;
receiving a search phrase from a first consumer of said plurality of consumers, specifying a set of requirements;
identifying a first provider of said plurality of providers matching said set of requirements;
creating a chat room for said search query, as a response to receiving said search query; and
facilitating both of said first provider and said first consumer to participate in said chat room.

8. The machine readable medium of claim 7, further comprising one or more instructions for:
inviting said first provider to said chat room,
wherein said first provider becomes a participant of said chat room by accepting the invitation sent by said inviting,
wherein said first provider and said first consumer interact in said chat room upon joining said chat room.

9. The machine readable medium of claim 8, wherein said first provider is unavailable when said invitation is sent, further comprising one or more instructions for:
notifying said first consumer of the unavailability of said first provider; and
upon said first provider becoming available, facilitating said first provider to join said chat room.

10. The machine readable medium of claim 7, wherein said first provider and said first consumer are invited to join said chat room as a response to said search query.

11. The machine readable medium of claim 10, further comprising one or more instructions for automatically joining said first provider and said first consumer to said chat room.

12. The machine readable medium of claim 11, wherein said identifying identifies a set of providers matching said set of requirements, said response to said search query containing identifiers of said set of providers, further comprising one or more instructions for:
receiving selection data representing said first provider, as having been selected by said first consumer; and
adding only said first provider, but not others of said plurality of providers, to said chat room.

13. A computing system comprising:
a plurality of provider devices to facilitate a plurality of providers to provide corresponding offerings;
a plurality of consumer devices to enable a plurality of consumers to connect with providers of desired offerings; and
a server system operable to:
maintain presence information indicating which ones of said plurality of consumers and said plurality of providers are presently logged in to said server system;
receive a search phrase from a first consumer using a first consumer device, specifying a set of requirements, wherein said first consumer is contained in said plurality of consumers and said first consumer device is contained in said plurality of consumer devices;
identify a first provider of said plurality of providers matching said set of requirements, said first provider using a first provider device of said plurality of provider devices;
create a chat room for said search query, as a response to receiving said search query; and
facilitate both of said first provider using said first provider device and said first consumer using said first consumer device to participate in said chat room.

14. The computing system of claim 13, wherein said server system is further operable to:
invite said first provider to said chat room,
wherein said first provider becomes a participant of said chat room by accepting the invitation sent by said inviting,
where said first provider and said first consumer interact in said chat room upon joining said chat room.

15. The computing system of claim 14, wherein said first provider is unavailable when said invitation is sent, said server system further operable to:
notify said first consumer of the unavailability of said first provider; and
upon said first provider becoming available, facilitate said first provider to join said chat room.

16. The computing system of claim 13, wherein said first provider and said first consumer are invited to join said chat room by said server system as a response to said search query.

17. The computing system of claim 16, wherein said server system is further operable to automatically join said first provider and said first consumer to said chat room.

18. The computing system of claim 13, wherein said server system identifies a set of providers matching said set of requirements, said response to said search query containing identifiers of said set of providers, said server system further operable to:
receive selection data representing said first provider, as having been selected by said first consumer; and
add only said first provider, but not others of said plurality of providers, to said chat room.
